(19) United States
(12) Patent Application Publication
(10) Pub. No.: US 2009/0028211 A1
(43) Pub. Date: Jan. 29, 2009

(54) ULTRASONIC DIAGNOSTIC APPARATUS

(76) Inventor: Shinichi Amemiya, Tokyo (JP)

Correspondence Address: PATRICK W. RASCHE (20459);ARMSTRONG TEASDALE LLP, ONE METROPOLITAN SQUARE, SUITE 2600, ST. LOUIS, MO, 63102-2740, US

(21) Appl. No.: 12/179,419

(22) Filed: Jul. 24, 2008

(30) Foreign Application Priority Data
Jul. 24, 2007 (JP) 2007-191514

(51) Int. Cl. G01K 11/22

(52) U.S. Cl. 374/117; 374/E11.009

(57) ABSTRACT

An ultrasonic diagnostic apparatus includes an ultrasonic probe having a plurality of transducers arranged and a plurality of temperature sensors located along a direction of arranging the transducers, and a temperature calculation device for obtaining a maximum temperature on the basis of the detected temperatures of the plurality of temperature sensors.

### BACKGROUND OF THE INVENTION

The present invention relates to an ultrasonic diagnostic apparatus, and more particularly to an ultrasonic diagnostic apparatus that is capable of precisely detecting a surface temperature of an ultrasonic probe even if the number of temperature sensors that are located within the ultrasonic probe is small.

Up to now, there has been known an ultrasonic diagnostic apparatus having plural temperature sensors arranged at plural locations close to a transducer of the ultrasonic probe (for example, refer to Patent document 1).

[Patent Document 1] Japanese Unexamined Patent Publication No. Hei 8 (1996)-56942

The above conventional ultrasonic diagnostic apparatus cannot detect a maximum temperature in the case where a maximum temperature point exists between one temperature sensor and another temperature sensor. Therefore, there arises such a problem that a large number of temperature sensors must be located within a linear type ultrasonic probe and a convex type ultrasonic probe so as to narrow intervals between the respective temperature sensors.

### BRIEF DESCRIPTION OF THE INVENTION

It is desirable that the problem described previously is solved.

According to a first aspect of the invention, there is provided an ultrasonic diagnostic apparatus, including: an ultrasonic probe having a plurality of transducers arranged and a plurality of temperature sensors located along a direction of arranging the transducers; and a temperature calculation device for obtaining a maximum temperature on the basis of the detected temperatures of the plurality of temperature sensors.

In the ultrasonic diagnostic apparatus according to the first aspect, since the maximum temperature is calculated on the basis of the detected temperatures of the plural temperature sensors, the maximum temperature can be obtained even if the maximum temperature point exists between one temperature sensor and another temperature sensor. Accordingly, because the intervals between the respective temperature sensors can be widened to some degree, it is possible to reduce the number of temperature sensors that are disposed within the linear type ultrasonic probe or the convex type ultrasonic probe.

According to a second aspect of the invention, there is provided the ultrasonic diagnostic apparatus according to the first aspect, wherein the number of temperature sensors is three or more.

In the ultrasonic diagnostic apparatus according to the second aspect, because the number of temperature sensors is three or 1 more, it is possible to improve the calculation precision of the maximum temperature (for example, the curve fitting of a curve is enabled).

According to a third aspect of the invention, there is provided the ultrasonic diagnostic apparatus according to the first or second aspect, wherein the number of temperature sensors is 18 or lower.

It is preferable that the number of temperature sensors is set such that one to three temperature sensors exist within the minimum opening at the time of transmission. With the above configuration, three temperature sensors exist at the opening and in the vicinity of the opening at the time of transmission, and the calculation precision of the maximum temperature can be improved.

When the number of temperature sensors is 18, three temperature sensors exist within the opening even if the opening length at the time of transmission is ⅙ of the transducer arrangement length. Because the necessity that the number of temperature sensors is made larger than three is low, the number of temperature sensors can be set to 18 or lower.

According to a fourth aspect of the invention, there is provided the ultrasonic diagnostic apparatus according to any one of the first to third aspects, wherein the number of temperature sensors is equal to or higher than 8 and equal to or lower than 12.

It is preferable that the number of temperature sensors is set such that one to three temperature sensors exist within the minimum opening at the time of transmission. With the above configuration, three temperature sensors exist at the opening and in the vicinity of the opening at the time of transmission, and the calculation precision can be improved.

When the number of temperature sensors is 8 to 12, one to three temperature sensors exist within the opening even if the opening length at the time of transmission is ⅙ of the transducer arrangement length.

According to a fifth aspect of the invention, there is provided the ultrasonic diagnostic apparatus according to any one of the first to fourth aspects, wherein the temperature calculation device obtains the maximum temperature on the basis of the detected temperatures from two temperature sensors, that is, the temperature sensor that detects the maximum temperature, and the temperature sensor which is higher in the detected temperature among the temperature sensors adjacent to the temperature sensor that detects the maximum temperature.

In the ultrasonic diagnostic apparatus according to the fifth aspect, the maximum temperature is calculated on the basis of two points closest to the maximum temperature point. Because the maximum temperature is calculated on the basis of the two points, the calculation amount can be reduced.

According to a sixth aspect of the invention, there is provided the ultrasonic diagnostic apparatus according to any one of the aspects second to fourth aspects, wherein the temperature calculation device obtains the maximum temperature on the basis of the detected temperatures from three temperature sensors, that is, the temperature sensor that detects the maximum temperature, and the temperature sensors adjacent to the temperature sensor that detects the maximum temperature.

In the ultrasonic diagnostic apparatus according to the sixth aspect, the maximum temperature is calculated on the basis of three points closest to the maximum temperature point. Because the maximum temperature is calculated on the basis of the three points, the calculation precision is enhanced.

According to a seventh aspect of the invention, there is provided the ultrasonic diagnostic apparatus according to any one of the first to sixth aspects, wherein the temperature calculation device calculates a temperature profile on the basis of the geometric positions and detected temperatures of the plurality of temperature sensors to obtain the maximum temperature.

In the ultrasonic diagnostic apparatus according to the seventh aspect, since the temperature profile is calculated on the basis of the geometric positions and detected temperatures of the plurality of temperature sensors, the maximum temperature can be obtained even if the maximum temperature point exists between the temperature sensors. Accordingly, because intervals between the temperature sensors can be widened to some degree, it is possible to reduce the number of temperature sensors that are located within the linear type ultrasonic probe or the convex type ultrasonic probe.

According to an eighth aspect of the invention, there is provided the ultrasonic diagnostic apparatus according to any one of the first to seventh aspects, wherein the temperature calculation device calculates a temperature profile by a curve fitting.

In the ultrasonic diagnostic apparatus according to the eighth aspect, the maximum temperature point existing between the temperature sensors can be obtained by the curve fitting.

According to a ninth aspect of the invention, there is provided the ultrasonic diagnostic apparatus according to the eighth aspect, wherein the temperature calculation device calculates the temperature profile by the curve fitting using a quadratic function.

In the ultrasonic diagnostic apparatus according to the ninth aspect, the maximum temperature point existing between the temperature sensors can be obtained by the curve fitting using the quadratic function.

According to a tenth aspect of the invention, there is provided the ultrasonic diagnostic apparatus according to the eighth aspect, wherein the temperature calculation device calculates the temperature profile by the curve fitting using a Gaussian function.

In the ultrasonic diagnostic apparatus according to the tenth aspect, the maximum temperature point existing between the temperature sensors can be obtained by the curve fitting using the Gaussian function.

According to an eleventh aspect of the invention, there is provided the ultrasonic diagnostic apparatus according to the eighth aspect, wherein the temperature calculation device calculates the temperature profile by the curve fitting using a raised cosine function.

In the ultrasonic diagnostic apparatus according to the eleventh aspect, the maximum temperature point existing between the temperature sensors can be obtained by the curve fitting using the raised cosine function.

According to a twelfth aspect of the invention, there is provided the ultrasonic diagnostic apparatus according to the tenth or eleventh aspect, wherein the temperature calculation device calculates a temperature profile on the basis of the geometric positions and detected temperatures of four or more temperature sensors to obtain the maximum temperature.

In the ultrasonic diagnostic apparatus according to the twelfth aspect, because the temperature profile is calculated on the basis of the four or more temperature sensors, the calculation precision can be improved.

According to a thirteenth aspect of the invention, there is provided the ultrasonic diagnostic apparatus according to any one of the first to twelfth aspects, further including a temperature control device that conducts a control for preventing a temperature from rising when the maximum temperature exceeds a permissible temperature.

In the ultrasonic diagnostic apparatus according to the thirteenth aspect, the surface temperature of the ultrasonic probe can be prevented from being excessively high.

According to a fourteenth aspect of the invention, there is provided the ultrasonic diagnostic apparatus according to the thirteenth aspect, wherein the temperature control device drops a transducer drive voltage.

In the ultrasonic diagnostic apparatus according to the fourteenth aspect, by dropping the transducer drive voltage, the surface temperature of the ultrasonic probe can be prevented from being excessively high without stopping the driving of the transducer by dropping the transducer drive voltage.

According to a fifteenth aspect of the invention, there is provided the ultrasonic diagnostic apparatus according to the thirteenth aspect, wherein the temperature control device reduces a frame rate.

In the ultrasonic diagnostic apparatus according to the fifteenth aspect, by reducing the frame rate, the surface temperature of the ultrasonic probe can be prevented from being excessively high without stopping the driving of the transducer.

According to a sixteenth aspect of the invention, there is provided the ultrasonic diagnostic apparatus according to the thirteenth aspect, wherein the temperature control device stops the driving of the transducer.

In the ultrasonic diagnostic apparatus according to the sixteenth aspect, the surface temperature of the ultrasonic probe can be prevented from being excessively high since the driving of the transducer stops.

According to a seventeenth aspect of the invention, there is provided the ultrasonic diagnostic apparatus according to the first to sixteenth aspects, further including a high temperature informing device for informing of a fact that the maximum temperature exceeds a permissible temperature.

In the ultrasonic diagnostic apparatus according to the seventeenth aspect, the high temperature informing device informs an operator that the surface temperature of the ultrasonic probe becomes high.

According to the ultrasonic diagnostic apparatus of the invention, the surface temperature of the ultrasonic probe can be precisely detected even if the number of temperature sensors that are located within the linear type ultrasonic probe or the convex type ultrasonic probe is not large.

The ultrasonic diagnostic apparatus according to the invention can be applied in detecting of the surface temperature of the ultrasonic diagnostic apparatus in use.

Further objects and advantages of the present invention will be apparent from the following description of the preferred embodiments of the invention as illustrated in the accompanying drawings.

### BRIEF DESCRIPTION OF THE DRAWINGS

FIG. 1 is a partially cross-sectional view showing an ultrasonic probe according to a first embodiment.

FIG. 2 is a cross-sectional view taken along a line V-V′.

FIG. 3 is a block diagram showing an ultrasonic diagnostic apparatus according to a first embodiment.

FIG. 4 is a graph where the detected temperatures are plotted.

FIG. 5 is an exemplary diagram showing a temperature profile obtained by curve fitting using three points.

FIG. 6 is an exemplary diagram showing a temperature profile obtained by curve fitting using seven points.

FIG. 7 is an exemplary diagram showing a temperature profile obtained by curve fitting using two points.

### DETAILED DESCRIPTION OF THE INVENTION

Hereinafter, the invention will be described in more detail with reference to the embodiments shown in the figures. The invention is not limited by the embodiments.

### First Embodiment

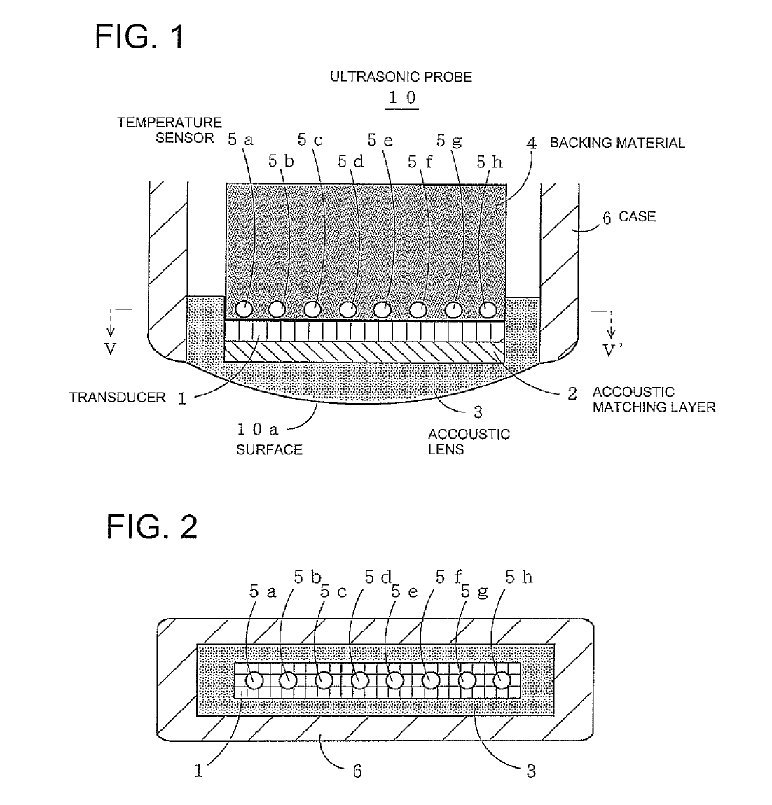

FIG. 1 is a partially cross-sectional view showing an ultrasonic diagnostic probe 10 according to a first embodiment. FIG. 2 is a cross-sectional view taken along a line V-V′.

The ultrasonic diagnostic probe 10 is a convex type ultrasonic probe which includes a large number of transducers 1, an acoustic matching layer 2, an acoustic lens 3, a backing material 4, plural temperature sensors 5a to 5h that are arranged in the vicinity of the transducers 1 (in the vicinity of the surface 10a), and a case 6.

One hundred or more transducers 1 are arranged in the lateral direction of FIG. 1, and about several transducers 1 are arranged in a direction perpendicular to the paper surface of FIG. 1. The plural temperature sensors 5a to 5h are arranged at regular intervals in the lateral direction of FIG. 1.

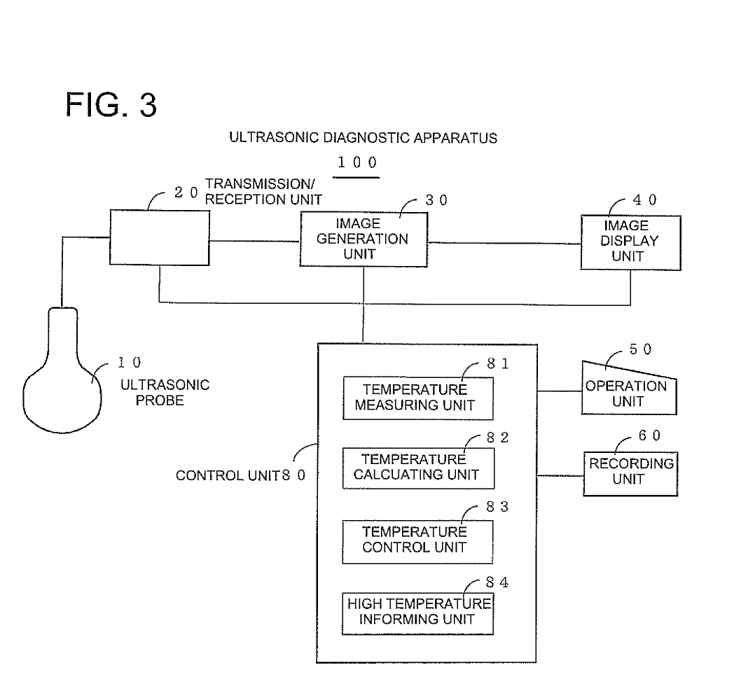

FIG. 3 is a structural block diagram showing an ultrasonic diagnostic apparatus 100 according to a first embodiment.

The ultrasonic diagnostic apparatus 100 includes an ultrasonic probe 10, a transmission/reception unit 20 that drives the transducers 1 of the ultrasonic probe 10 to scan the interior of a subject to be detected with an ultrasonic beam, an image generation unit 30 that generates an ultrasonic image on the basis of a signal that has been obtained by the transmission/reception unit 20, an image display unit 40 that displays an ultrasonic image, an operation unit 50 with which an operator gives an instruction or data, a recording unit 60 that records an ultrasonic image, and a control unit 80 that controls the entire ultrasonic diagnostic apparatus.

The control unit 80 includes a temperature measuring unit 81 that collects the detected temperatures from the temperature sensors 5a to 4h, a temperature calculation unit 82 that calculates a temperature profile on the basis of the diagnostic positions and detected temperatures of the temperature sensors 5a to 5h to obtain a maximum temperature, a temperature control unit 83 that conducts a control for preventing the temperature from rising when the maximum temperature exceeds a permissible temperature, and a high temperature notifying unit 84 that notifies of a fact that the maximum temperature exceeds the permissible temperature.

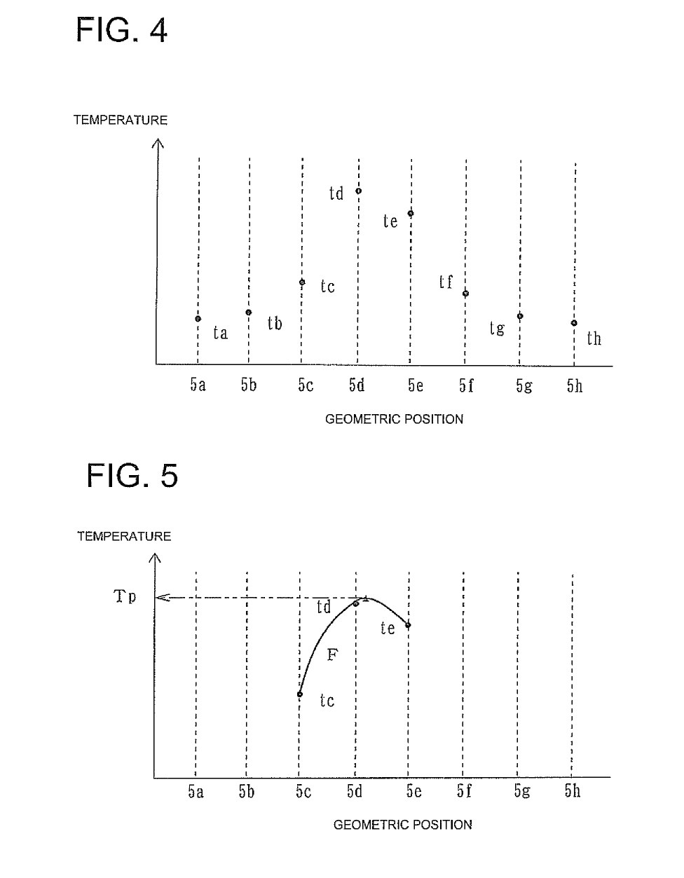

As shown in FIG. 4, the temperature calculation unit 82 plots the detected temperatures ta to th from the respective temperature sensors 5a to 5h on a graph with the geometric positions of the temperature sensors 5a to 5h as the axis of abscissa and the temperature as the axis of ordinate.

Then, as shown in FIG. 5, the temperature calculation unit 82 curve-fits a quadratic function (or Gaussian function or a raised cosine function) at three points consisting of a maximum temperature td among the detected temperatures ta to th and detected temperatures tc and te that are adjacent to the maximum temperature td, and obtains a maximum temperature Tp from the obtained temperature profile F.

The temperature control unit 83 drops an oscillation drive voltage when the maximum temperature Tp exceeds a permissible temperature. When the maximum temperature Tp is not equal to or lower than the permissible temperature after one minute, the temperature control unit 83 drops a frame rate. When the maximum temperature Tp is not equal to or lower than the permissible temperature after another minute, the temperature control unit 83 stops the driving of the transducers 1. Then, when the maximum temperature Tp is lower than the permissible temperature, for example, by 2° C., the temperature control unit 83 restarts to drive the transducers 1 by the original transducer drive voltage and the frame rate.

The high temperature informing unit 84 displays on the image display unit 40 that the maximum temperature Tp exceeds the permissible temperature and a control is made to prevent the temperature from rising when the maximum temperature exceeds the permissible temperature. Then, when the maximum temperature Tp becomes lower than the permissible temperature, for example, by 2° C., the high temperature informing unit 84 displays on the image display unit 40 that the control for preventing the temperature from rising is stopped.

According to the ultrasonic diagnostic apparatus 100 of the first embodiment, the maximum temperature can be obtained even if the maximum temperature point exists between the temperature sensors. Accordingly, because the intervals between the respective temperature sensors can be widened to some degree, it is possible to reduce the number of temperature sensors 5a to 5h that are disposed within the ultrasonic probe 10.

### Second Embodiment

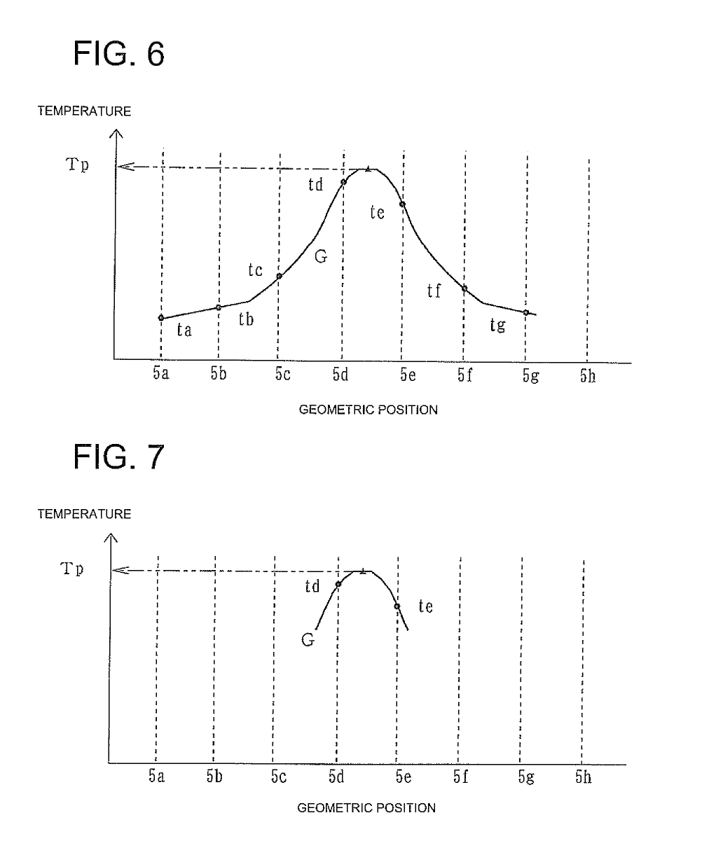

As shown in FIG. 6, alternatively, in the temperature calculation unit 82, the Gaussian function (or quadratic function, or the raised cosine function) is curve-fitted at seven points consisting of the maximum temperature td among the detected temperatures ta to th, the detected temperatures tc and te that are adjacent to the maximum temperature td, and the detected temperatures ta, tb, tf, and tg, which are further outside of the detected temperatures tc and te. Then, the maximum temperature Tp can be obtained from the obtained temperature profile G.

### Third Embodiment

As shown in FIG. 7, alternatively, in the temperature calculation unit 82, the Gaussian function (or quadratic function, or the raised cosine function) of a predetermined configuration is curve-fitted at two points consisting of the maximum temperature td among the detected temperatures ta to th and a higher detected temperature te of the detected temperatures tc and te which are adjacent to the maximum temperature td. The maximum temperature Tp can be obtained from the obtained temperature profile G.

### Fourth Embodiment

The same advantages are obtained even in the linear type ultrasonic probe.

Many widely different embodiments of the invention may be configured without departing from the spirit and the scope of the present invention. It should be understood that the present invention is not limited to the specific embodiments described in the specification, except as defined in the appended claims.

1. An ultrasonic diagnostic apparatus, comprising:
an ultrasonic probe comprising a plurality of transducers and a plurality of temperature sensors located along a direction of orientation of said plurality of transducers; and
a temperature calculation device configured to determine a maximum temperature based on a detected temperatures of said plurality of temperature sensors.

2. The ultrasonic diagnostic apparatus according to claim 1, wherein said plurality of temperature sensors comprises at least three temperature sensors.

3. The ultrasonic diagnostic apparatus according to claim 1, wherein said plurality of temperature sensors comprises no more than eighteen temperature sensors.

4. The ultrasonic diagnostic apparatus according to claim 1, wherein said plurality of temperature sensors comprises at least eight temperature sensors and no more than twelve temperature sensors.

5. The ultrasonic diagnostic apparatus according to claim 1, wherein said temperature calculation device is configured to determine the maximum temperature based on detected temperatures from two temperature sensors, wherein a first temperature sensor detects the maximum temperature, and a second temperature sensor having a higher detected temperature among the temperature sensors that are adjacent to said first temperature sensor.

6. The ultrasonic diagnostic apparatus according to claim 2, wherein said temperature calculation device is configured to determine the maximum temperature based on the detected temperatures from three temperature sensors wherein a first temperature sensor detects the maximum temperature, and a second temperature sensor and a third temperature sensor are adjacent to said first temperature sensor.

7. The ultrasonic diagnostic apparatus according to claim 1, wherein said temperature calculation device is configured to calculate a temperature profile based on geometric positions and detected temperatures of said plurality of temperature sensors in order to obtain the maximum temperature.

8. The ultrasonic diagnostic apparatus according to claim 5, wherein said temperature calculation device is configured to calculate a temperature profile based on geometric positions and detected temperatures of said plurality of temperature sensors in order to obtain the maximum temperature.

9. The ultrasonic diagnostic apparatus according to claim 1, wherein said temperature calculation device is configured to calculate a temperature profile by a curve fitting.

10. The ultrasonic diagnostic apparatus according to claim 5, wherein said temperature calculation device is configured to calculate a temperature profile by a curve fitting.

11. The ultrasonic diagnostic apparatus according to claim 7, wherein said temperature calculation device is configured to calculate the temperature profile by a curve fitting.

12. The ultrasonic diagnostic apparatus according to claim 9, wherein said temperature calculation device is configured to calculate the temperature profile by the curve flitting using a quadratic function.

13. The ultrasonic diagnostic apparatus according to claim 9, wherein said temperature calculation device is configured to calculate the temperature profile by the curve fitting using a Gaussian function.

14. The ultrasonic diagnostic apparatus according to claim 9, wherein said temperature calculation device is configured to calculate the temperature profile by the curve fitting using a raised cosine function.

15. The ultrasonic diagnostic apparatus according to claim 13, wherein said temperature calculation device is configured to calculate the temperature profile based on geometric positions and detected temperatures of at least four temperature sensors of said plurality of temperature sensors in order to obtain the maximum temperature.

16. The ultrasonic diagnostic apparatus according to claim 1, further comprising a temperature control device configured to conduct a control for preventing a temperature from rising when the maximum temperature exceeds a permissible temperature.

17. The ultrasonic diagnostic apparatus according to claim 16, wherein said temperature control device is configured to reduce a transducer drive voltage.

18. The ultrasonic diagnostic apparatus according to claim 16, wherein said temperature control device is configured to reduce a frame rate.

19. The ultrasonic diagnostic apparatus according to claim 16, wherein said temperature control device is configured to stop driving a transducer of said plurality of transducers.

20. The ultrasonic diagnostic apparatus according to claim 1, further comprising a high temperature informing device configured to generating a signal whole the maximum temperature exceeds a permissible temperature.
